(19) United States
(12) Patent Application Publication
(10) Pub. No.: US 2019/0197733 A1
(43) Pub. Date: Jun. 27, 2019

(54) METHOD AND SYSTEM FOR MASS PRODUCTION OF PANORAMIC CAMERA

(71) Applicant: SHENZHEN PISOFTWARE TECHNOLOGY CO., LTD., Shenzhen, Guangdong (CN)

(72) Inventors: Yahui Liu, Shenzhen, Guangdong (CN); Jingcheng Shen, Shenzhen, Guangdong (CN); Chao Wang, Shenzhen, Guangdong (CN)

(21) Appl. No.: 16/325,386

(22) PCT Filed: Mar. 31, 2017
(86) PCT No.: PCT/CN2017/079090

§ 371 Date: Feb. 13, 2019

(30) Foreign Application Priority Data
Nov. 24, 2016 (CN) 201611043274.4

(51) Int. Cl. G06T 7/80; H04N 17/00; G01J 3/02; H04N 5/232

(52) U.S. Cl. CPC G06T 7/80; H04N 17/002; G03B 43/00; H04N 5/23238; G01J 3/0202

(57) ABSTRACT

Provided are a method and system for mass production of a panoramic camera. The method includes steps of setting a calibration room for a to-be-produced camera; calculating a calibration parameter of the to-be-produced camera, and performing panoramic splicing of the to-be-produced camera according to the calibration parameter; determining whether the to-be-produced camera is qualified according to an effect of the panoramic splicing of the to-be-produced camera, and if there is no serious splicing seam in the effect of panoramic photo splicing, mass-producing the to-be-produced camera by a mass production device. According to the method and system for mass production of a panoramic camera, the calibration room can be quickly set, and efficient inspection of the panoramic camera splicing is performed according to the calibration parameter, thereby making the mass production of the panoramic camera efficient, stable and reliable, and implementing quick mass production of the panoramic camera.

### TECHNICAL FIELD

The present application relates to the field of panoramic cameras, and in particular, to a method and system for mass production of a panoramic camera.

### BACKGROUND

With continuous development of panoramic cameras, the demand for the panoramic cameras has been increasing. However, the production efficiency of panoramic cameras is low because the photo splicing effect of panoramic cameras needs to be inspected during the production process.

At present, mass production of the panoramic cameras is still at an explorative stage, and major manufacturers have not found an effective method for inspecting the splicing effect of panoramic photos. Therefore, a method for solving the problem of inspecting the panoramic photo splicing effect to achieve mass production needs to be developed.

### SUMMARY

In view of all above, embodiments of the present application provide a method and system for mass production of a panoramic camera, which can perform efficient inspection of the panoramic camera splicing according to a calibration parameter through quick setting of a calibration room.

In the first aspect, a method for mass production of a panoramic camera is provided. The method includes: setting a calibration room for a to-be-produced camera;

calculating a calibration parameter of the to-be-produced camera, and performing panoramic splicing of the to-be-produced camera according to the calibration parameter;

determining whether the to-be-produced camera is qualified according to an effect of the panoramic splicing of the to-be-produced camera, and if there is no serious splicing seam in the effect of panoramic photo splicing, a mass production device mass-produces the to-be-produced camera.

Preferably, the method for setting the calibration room includes:

determining a ratio of length to width to height of the calibration room; and

determining the number of calibration feature patterns and corresponding locations.

Preferably, the method for mass production of a panoramic camera further includes:

controlling the to-be-produced camera to take a photo, and receiving the photo returned by the to-be-produced camera;

calculating a calibration parameter of the to-be-produced camera according to the returned photo;

performing panoramic splicing of the returned photo once according to the calibration parameter of the to-be-produced camera, and returning the calibration parameter to the to-be-produced camera.

Preferably, the ratio of length to width to height of the calibration room is 4:4:3, and the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

Preferably, the calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

Preferably, a to-be-produced camera fixing apparatus is disposed at a geometric center position of the bottom of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each include a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

Compared with the prior art, the present application provides a method for mass production of a panoramic camera which can perform efficient inspection of the panoramic camera splicing according to the calibration parameter through quick setting of the calibration room, thereby making the mass production of the panoramic camera efficient, stable and reliable, and implementing quick mass production of the panoramic camera. In addition, the calibration feature patterns in the calibration room enable the to-be-produced camera to fully cover all areas of the calibration room during shooting and thus avoid blind corners, thereby also making a panoramic splicing comparison accurate and efficient for the panoramic camera. Therefore, high efficiency of mass production is also ensured.

In the second aspect, the present application provides a system for mass production of a panoramic camera, including:

a room calibration module configured to set a calibration room for a to-be-produced camera;

a parameter calibration module configured to calculate a calibration parameter of the to-be-produced camera, and perform panoramic splicing of the to-be-produced camera according to the calibration parameter; and

a mass production determination module configured to determine whether the to-be-produced camera is qualified according to an effect of the panoramic splicing of the to-be-produced camera, where if there is no serious splicing seam in the effect of panoramic photo splicing, the to-be-produced camera is mass-produced by a mass production device.

Preferably, the room calibration module includes a dimension calibration module and a feature pattern calibration module, where the dimension calibration module is configured to determine a ratio of length to width to height of the calibration room; and the feature pattern calibration module is configured to determine the number of calibration feature patterns and corresponding locations thereof.

Preferably, the parameter calibration module includes a camera control module, a parameter determination module and a camera inspection module, where

the camera control module is configured to control the to-be-produced camera to take a photo, and receive the photo returned by the to-be-produced camera;

the parameter determination module is configured to calculate a calibration parameter of the to-be-produced camera according to the returned photo; and

the camera inspection module is configured to perform panoramic splicing of the returned photo once according to the calibration parameter of the to-be-produced camera, and return the calibration parameter to the to-be-produced camera.

Preferably, the ratio of length to width to height of the calibration room is 4:4:3, and the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

Preferably, the calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

Preferably, a to-be-produced camera fixing apparatus is disposed at a geometric center position of the bottom of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each include a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

Compared with the prior art, the present application provides a system for mass production of a panoramic camera, which can perform efficient inspection of the panoramic camera splicing through quick setting of the calibration room and according to the calibration parameter, thereby making the mass production of the panoramic camera efficient, stable and reliable, and implementing quick mass production of the panoramic camera. In addition, the calibration feature patterns in the calibration room enable the to-be-produced camera to fully cover all areas of the calibration room during shooting and thus avoid blind corners, thereby also making a panoramic splicing comparison accurate and efficient for the panoramic camera. Therefore, high efficiency of mass production is also ensured.

### BRIEF DESCRIPTION OF DRAWINGS

In order to explain technical solutions of the present application more clearly, the accompanying drawings used in the description of the embodiments will be briefly introduced below. Apparently, the accompanying drawings in the following description are only some embodiments of the present application, and a person of ordinary skill in the art can also obtain other accompanying drawings according to these accompanying drawings without any creative work.

FIG. 1 is a schematic flow chart of an implementation of a method for mass production of a panoramic camera disclosed by an embodiment of the present application;

FIG. 2 is a schematic flow chart of another implementation of a method for mass production of a panoramic camera disclosed by an embodiment of the present application;

FIGS. 3A and 3B are schematic structural views of an implementation of a calibration room disclosed by an embodiment of the present application;

FIG. 4 is a schematic structural view of an implementation of a calibration feature pattern disclosed by an embodiment of the present application;

FIG. 5 is a schematic structural view of an implementation of a system for mass production of a panoramic camera disclosed by an embodiment of the present application; and

FIG. 6 is a schematic structural view of another implementation of a system for mass production of a panoramic camera disclosed by an embodiment of the present application.

Reference numerals of main components

| | |
|---|---|
| Room calibration module | 10 |
| Parameter calibration module | 20 |
| Mass production determination module | 30 |
| Dimension calibration module | 100 |
| Feature pattern calibration module | 102 |
| Camera control module | 200 |
| Parameter determination module | 202 |
| Camera inspection module | 204 |

### DETAILED DESCRIPTION

To make the objectives, technical solutions, and advantages of the present application clearer and more comprehensible, the following further describes the present application in detail with reference to the accompanying drawings and embodiments. It should be understood that the specific embodiments described herein are merely used to explain the present application and are not intended to limit the present application.

In addition, the terms “include” and “have” and any variations thereof in the specification and claims of the present application and the above accompanying drawings are intended to cover a non-exclusive inclusion. For example, processes, methods, systems, products, or devices that include a series of steps or units is not limited to the listed steps or units, but optionally also includes steps or units not listed, or, optionally, other steps or units inherent to these processes, methods, products or devices.

The implementation of the present application will be described in detail below with reference to specific embodiments.

Embodiments of the present application provide a method and system for mass production of a panoramic camera, which can perform efficient inspection of panoramic camera splicing according to a calibration parameter through quick setting of a calibration room. Details are described below separately.

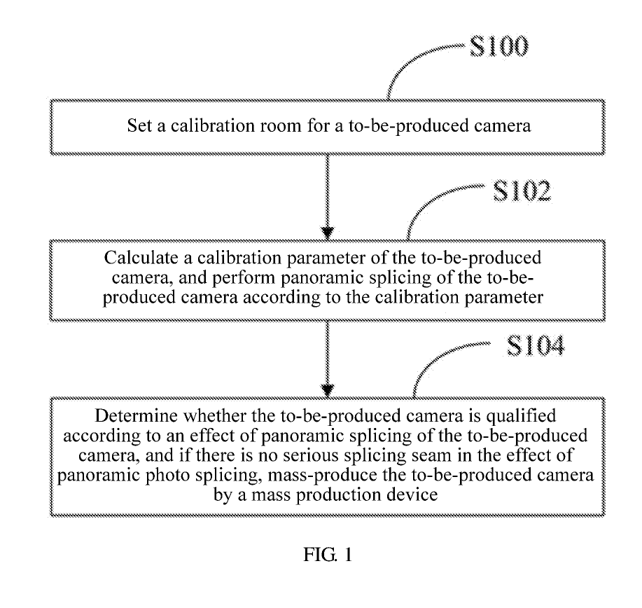

Reference is made to FIG. 1, which is a schematic flow chart of an implementation of a method for mass production of a panoramic camera disclosed by an embodiment of the present application. As shown in FIG. 1, a method for mass production of a panoramic camera disclosed by an embodiment of the present application includes steps:

Step S100: Set a calibration room for a to-be-produced camera.

Step S102: Calculate a calibration parameter of the to-be-produced camera, and perform panoramic splicing of the to-be-produced camera according to the calibration parameter.

Step S104: Determine whether the to-be-produced camera is qualified according to an effect of panoramic splicing of the to-be-produced camera, and if there is no serious splicing seam in the effect of panoramic photo splicing, mass-produce the to-be-produced camera by a mass production device.

In general, if a serious splicing seam occurs in the effect of the panorama photo splicing, it is determined that the to-be-produced camera is a defective product, and thus the to-be-produced camera is not mass-produced.

In the embodiment of the present application, by quickly setting a calibration room, performing efficient inspection of the panoramic camera splicing according to the calibration parameter, determining a splicing result, and providing quick mass production of the panoramic camera, the mass production of the panoramic camera is efficient, stable and reliable.

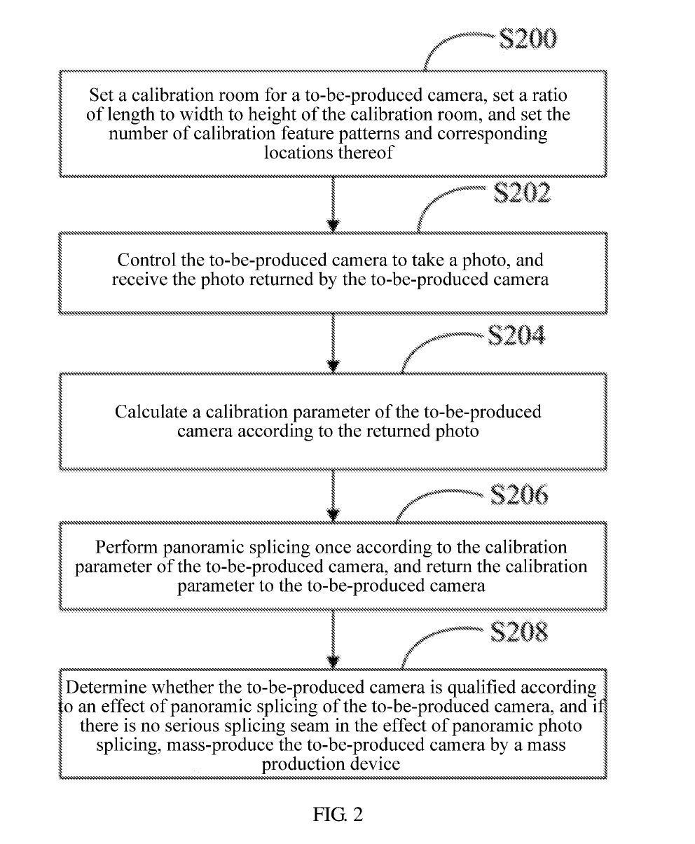

Reference is made to FIG. 2, which is a schematic flow chart of another implementation of a method for mass production of a panoramic camera disclosed by an embodiment of the present application. As shown in FIG. 2, a method for mass production of a panoramic camera disclosed by an embodiment of the present application includes the following steps:

Step S200: Set a calibration room for a to-be-produced camera, determine a ratio of length to width to height of the calibration room, and set the number of calibration feature patterns and corresponding locations thereof.

The number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

The calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

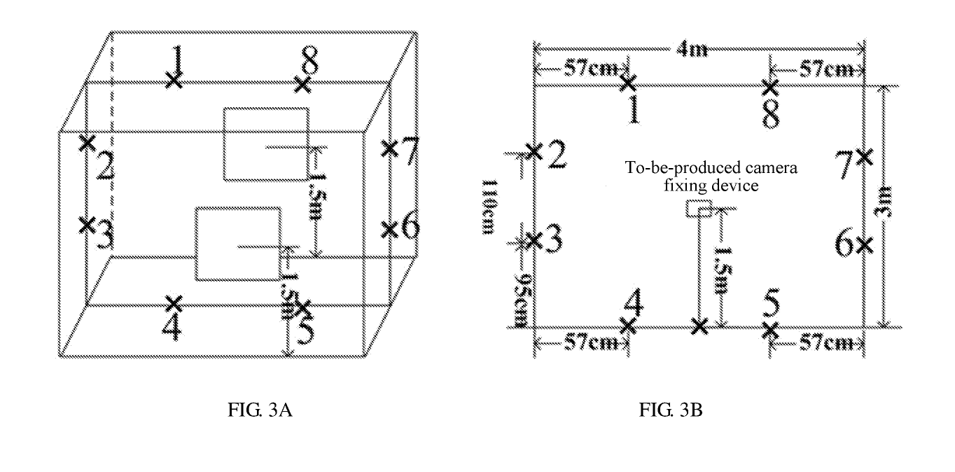

A to-be-produced camera fixing apparatus is disposed at a geometric center position of the bottom of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each include a black and white grid plate, and the two black and white grid plates are square plates with a 1:1 ratio of black to white; and the optical axis of the to-be-produced camera is perpendicular to the two black and white grid plates and passes through geometric centers of the two black and white grid plates. See FIGS. 3A and 3B for a detailed schematic view of the calibration room.

Step S202: Control the to-be-produced camera to take a photo, and receive the photo returned by the to-be-produced camera.

Step S204: Calculate a calibration parameter of the to-be-produced camera according to the returned photo; generally, store the calibration parameter to a non-volatile storage space of the to-be-produced camera after the to-be-produced camera receives the calibration parameter.

Step S206: Perform panoramic splicing once according to the calibration parameter of the to-be-produced camera, and return the calibration parameter to the to-be-produced camera.

Step S208: Determine whether the to-be-produced camera is qualified according to an effect of panoramic splicing of the to-be-produced camera, and if there is no serious splicing seam in the effect of panoramic photo splicing, mass-produce the to-be-produced camera by a mass production device; and if there is a serious splicing seam in the effect of panoramic photo splicing, the to-be-produced camera is a defective product and is not mass-produced.

In the embodiment of the present application, by quickly setting a calibration room, performing efficient inspection of the panoramic camera splicing according to the calibration parameter, determining a splicing result, and providing quick mass production of the panoramic camera, the mass production of the panoramic camera is efficient, stable and reliable.

Reference is made to FIGS. 3A and 3B, which is a schematic structural view of an implementation of a calibration room disclosed by an embodiment of the present application.

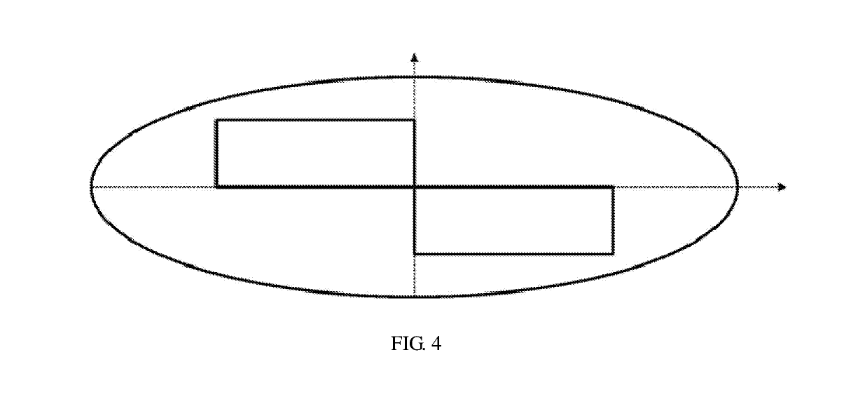

In this implementation, FIG. 3A is a stereoscopic view of the calibration room, where a ratio of length to width to height of the calibration room is 4:4:3, and calibration feature pattern includes 8 points identified by “X” (for convenience of description, the feature patterns are replaced with points). Please refer to FIG. 4 for specific calibration feature patterns.

Specifically, the length, width, and height of the calibration room are 4 m, 4 m, and 3 m, respectively, and it can be seen that the 8 calibration feature patterns may be connected to be a circle and intersect with a bisecting cross section. In addition, two opposite faces of side faces of the calibration room each include a black and white grid plate, and the black and white grid plate is a square plate with a ratio of 1:1; the black and white grid plate is a checkered plate formed by black alternating with white, and an optical axis of the to-be-produced camera is perpendicular to the two black and white grid plates and passes through geometric centers of the two black and white grid plates. In this implementation, the pair of black and white grid plates is configured to calibrate a binocular panoramic camera.

In other implementations, two pairs of black and white grid plates may be used on the side faces of the calibration room, and the two pairs of black and white grid plates are configured to calibrate a quad-ocular panoramic camera.

FIG. 3B are a plane view of a bisecting cross section. The specific locations of the 8 calibration feature patterns can be seen from FIG. 3B. In addition, as can be seen from the figure, a to-be-produced camera fixing apparatus is disposed at a ground center of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; and two opposite faces of side faces of the calibration room each include a black and white grid plate, so that the camera can shoot more areas during the shooting and avoid blind corners.

In the embodiment of the present application, by quickly setting a calibration room, performing efficient inspection of the panoramic camera splicing according to the calibration parameter, determining a splicing result, and providing quick mass production of the panoramic camera, the mass production of the panoramic camera is efficient, stable and reliable.

Reference is made to FIG. 4, which is a schematic structural view of an implementation of a calibration feature pattern disclosed by an embodiment of the present application. In this implementation, the calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

Specifically, area 2 and area 3 are two intersecting rectangles respectively, and intersect at the center of the ellipse. Area 1 within the ellipse region which is other than the area 2 and the area 3 presents a large color contrast to the area 2 and the area 3, to facilitate splicing inspection of the to-be-produced camera. Specifically, the area 1, the area 2 and the area 3 are generally black and white respectively, commonly known as black and white grids.

Certainly, there is another way for the rectangular area 2 and the area 3 to be symmetrical with respect to the origin of the ellipse, and details are not described herein again.

Eight calibration feature patterns in black and white grid format can implement the mass production splicing inspection of a to-be-produced binocular camera, and the 16 calibration feature patterns in black and white grid format can implement the mass production splicing inspection of a to-be-produced quad-ocular camera, where the 16 calibration feature patterns in black and white grid format are located at two pairs of faces of side faces of the calibration room.

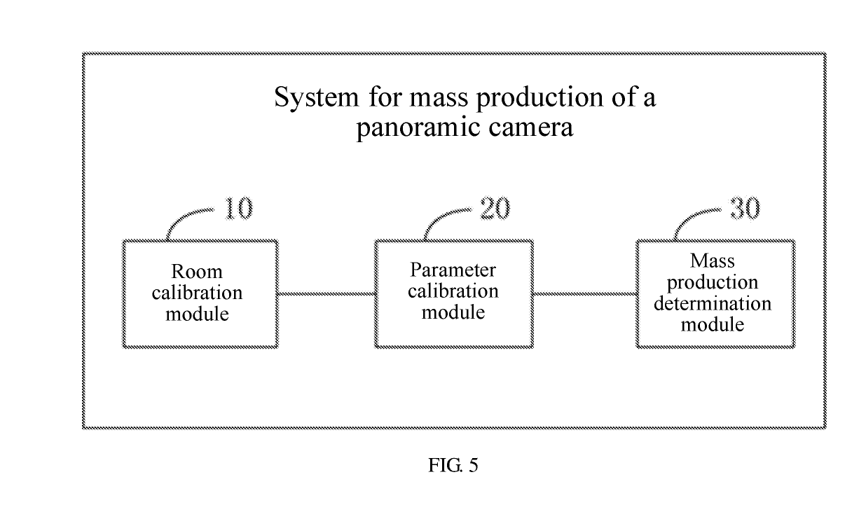

Reference is made to FIG. 5, which is a schematic structural view of an implementation of a system for mass production of a panoramic camera disclosed by an embodiment of the present application, where the system for mass production of a panoramic camera includes a room calibration module 10, a parameter calibration module 20, and a mass production determination module 30.

In this embodiment, the room calibration module 10 is configured to set a calibration room for a to-be-produced camera. The parameter calibration module 20 is configured to calculate a calibration parameter of the to-be-produced camera, and perform panoramic splicing of the to-be-produced camera according to the calibration parameter. The mass production determination module 30 is configured to determine whether the to-be-produced camera is qualified according to an effect of panoramic splicing of the to-be-produced camera, and if there is no serious splicing seam in the effect of panoramic photo splicing, a mass production device mass-produces the to-be-produced camera.

Similarly, the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

The calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

A to-be-produced camera fixing apparatus is disposed at a geometric center position of the bottom of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each include a black and white grid plate, and the two black and white grid plates are square plates with a 1:1 ratio of black to white; and the optical axis of the to-be-produced camera is perpendicular to the two black and white grid plates and passes through geometric centers of the two black and white grid plates. See FIG. 3 for a detailed schematic view of the calibration room, and details are not described here.

The to-be-produced camera is in communication with the system for mass production of a panoramic camera through a USB interface, and each module in the system for mass production of a panoramic camera controls the photographing of the to-be-produced camera, the transmission of the calibration parameter, and photo transmission and the like through a USB interface.

It is worth mentioning that in order to ensure the mass production calibration efficiency of the to-be-produced camera, a mass production firmware program is recorded in advance before a camera inspection calibration step, and the mass production firmware program is recorded through a USB interface.

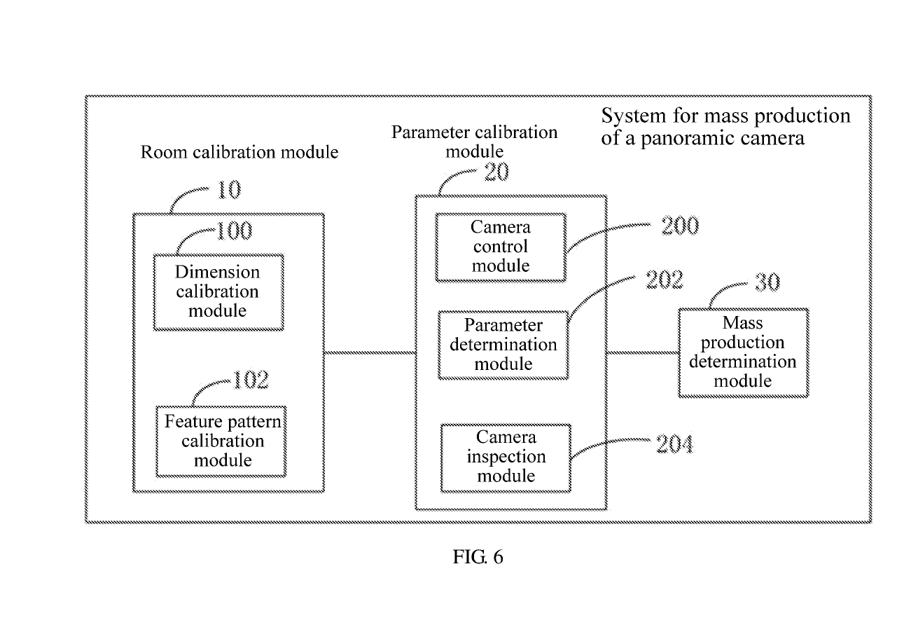

Reference is made to FIG. 6, which is a schematic structural view of another implementation of a system for mass production of a panoramic camera disclosed by an embodiment of the present application, where the system for mass production of a panoramic camera includes a room calibration module 10, a parameter calibration module 20, and a mass production determination module 30. The room calibration module 10 includes a dimension calibration module 100 and a feature pattern calibration module 102; and the parameter calibration module includes a camera control module 200, a parameter determination module 202, and a camera inspection module 204. Each module is connected by a certain communication method.

In this implementation, the dimension calibration module 100 is configured to determine a ratio of length to width to height of the calibration room; and the feature pattern calibration module 102 is configured to determine the number of calibration feature patterns and corresponding locations thereof.

The camera control module 200 is configured to control the to-be-produced camera to take a photo, and receive the photo returned by the to-be-produced camera; the parameter determination module 202 is configured to calculate a calibration parameter of the to-be-produced camera according to the returned photo; and the camera inspection module 204 is configured to control the to-be-produced camera to take a photo again, receive the photo returned by the to-be-produced camera again, and perform panoramic splicing once according to the calibration parameter of the to-be-produced camera.

More specifically, the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

The calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

A to-be-produced camera fixing apparatus is disposed at a geometric center position of the bottom of the calibration room, and the to-be-produced camera fixing apparatus includes a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each include a black and white grid plate, and the two black and white grid plates are square plates with a 1:1 ratio of black to white; and the optical axis of the to-be-produced camera is perpendicular to the two black and white grid plates and passes through geometric centers of the two black and white grid plates. See FIG. 3 for a detailed schematic view of the calibration room, and details are not described here.

The to-be-produced camera is in communication with the system for mass production of a panoramic camera through a USB interface, and each module in the system for mass production of a panoramic camera controls the photographing of the to-be-produced camera, the transmission of the calibration parameter, and photo transmission and the like through a USB interface.

It is worth mentioning that in order to ensure the mass production calibration efficiency of the to-be-produced camera, a mass production firmware program is recorded in advance before a camera inspection calibration step, and the mass production firmware program is recorded through a USB interface.

It should be noted that, for the sake of simple description, the foregoing method embodiments are all expressed as a series of action combinations, but those skilled in the art should understand that the present application is not limited by the described action sequence, because certain steps may be performed in other sequences or concurrently in accordance with the present application.

Secondly, those skilled in the art should also understand that the embodiments described in the specification are all preferred embodiments, and the actions and modules involved are not necessarily required by the present application.

In the above embodiments, the descriptions of the various embodiments are different, and for the parts that are not detailed in a certain embodiment, see the related descriptions of other embodiments.

In some embodiments provided by the present application, it should be understood that a disclosed device may be implemented in other manners. For example, the device embodiments described above are merely illustrative. For example, the division of units is only a logical function division, and in actual implementation, there may be another division manner. For example, multiple units or components may be combined or integrated into another system, or some features may be omitted or not implemented. In addition, the mutual coupling or direct coupling or communication connection shown or discussed may be an indirect coupling or communication connection through some interfaces, devices or units, and may be electrical or otherwise.

Units described as separate components may or may not be physically separated, and components displayed as units may or may not be physical units, that is, the units and the components may be located at one place, or may be distributed to multiple network units. Some or all of the units may be selected according to actual needs to achieve the objective of the solution of the embodiment.

In addition, each functional unit in each embodiment of the present application may be integrated into one processing unit, or each unit may exist physically separately, or two or more units may be integrated into one unit. The above integrated unit can be implemented in the form of hardware or in the form of a software functional unit.

The integrated unit, if implemented in the form of a software functional unit and sold or used as an independent product, may be stored in a computer readable memory. Based on such understanding, the technical solution of the present application, in essence or the contribution to the prior art, or all or part of the technical solution may be embodied in the form of a software product. The computer software product is stored in a memory, and includes a plurality of instructions used to cause a computer device (which may be a personal computer, a parameter calibration module, or a network device, etc.) to perform all or part of the steps of the method described in various embodiments of the present application. The foregoing memory includes various media that can store program codes, such as a USB flash disk, a read-only memory (ROM), a random access memory (RAM), a mobile hard disk, a magnetic disk, or an optical disc.

Those of ordinary skilled in the art can understand that all or some steps in various methods of the above embodiments can be completed through instructing related hardware by a program, and the program can be stored in a computer readable memory, and the memory may include a read only memory (ROM), a random access memory (RAM), a magnetic disk or an optical disc, etc.

The above are only the preferred embodiments of the present application, and are not intended to limit the present application. Any modifications, equivalent substitutions and improvements made within the spirit and principles of the present application should fall into the protection scope of the present application.

1. A method for mass production of a panoramic camera, wherein the method comprises:
setting a calibration room for a to-be-produced camera;
calculating a calibration parameter of the to-be-produced camera, and performing panoramic splicing of the to-be-produced camera according to the calibration parameter;
determining whether the to-be-produced camera is qualified according to an effect of the panoramic splicing of the to-be-produced camera, and if there is no serious splicing seam in the effect of panoramic photo splicing, a mass production device would mass produce the to-be-produced camera.

2. The method for mass production of a panoramic camera according to claim 1, wherein the method step of setting the calibration room comprises:
determining a ratio of length to width to height of the calibration room; and
determining the number of calibration feature patterns and corresponding locations thereof.

3. The method for mass production of a panoramic camera according to claim 1, wherein the method further comprises:
controlling the to-be-produced camera to take a photo, and receiving the photo returned by the to-be-produced camera;
calculating a calibration parameter of the to-be-produced camera according to the returned photo;
performing panoramic splicing of the returned photo once according to the calibration parameter of the to-be-produced camera, and returning the calibration parameter to the to-be-produced camera.

4. The method for mass production of a panoramic camera according to claim 2, wherein the ratio of length to width to height of the calibration room is 4:4:3, and the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

5. The method for mass production of a panoramic camera according to claim 4, wherein the calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

6. The method for mass production of a panoramic camera according to claim 1, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

7. A system for mass production of a panoramic camera, wherein the system comprises:
a room calibration module configured to set a calibration room for a to-be-produced camera;
a parameter calibration module configured to calculate a calibration parameter of the to-be-produced camera, and perform panoramic splicing of the to-be-produced camera according to the calibration parameter; and
a mass production determination module configured to determine whether the to-be-produced camera is qualified according to an effect of the panoramic splicing of the to-be-produced camera, wherein if there is no serious splicing seam in the effect of panoramic photo splicing, the to-be-produced camera is mass-produced by a mass production device.

8. The system for mass production of a panoramic camera according to claim 7, wherein the room calibration module comprises a dimension calibration module and a feature pattern calibration module, wherein
the dimension calibration module is configured to determine a ratio of length to width to height of the calibration room; and
the feature pattern calibration module is configured to determine the number of calibration feature patterns and corresponding locations thereof.

9. The system for mass production of a panoramic camera according to claim 7, wherein the parameter calibration module comprises a camera control module, a parameter determination module and a camera inspection module, wherein
the camera control module is configured to control the to-be-produced camera to take a photo, and receive the photo returned by the to-be-produced camera;
the parameter determination module is configured to calculate a calibration parameter of the to-be-produced camera according to the returned photo; and
the camera inspection module is configured to perform panoramic splicing of the returned photo once according to the calibration parameter of the to-be-produced camera, and return the calibration parameter to the to-be-produced camera.

10. The system for mass production of a panoramic camera according to claim 8, wherein the ratio of length to width to height of the calibration room is 4:4:3, and the number of the calibration feature patterns is 8; geometric centers of the 8 calibration feature patterns are located on the circumference of a same circle, and the geometric centers of the 8 calibration feature patterns are points at which the circumference of the circle intersects with an edge of a bisecting cross section of the calibration room.

11. The system for mass production of a panoramic camera according to claim 10, wherein the calibration feature patterns are each an ellipse, and a middle portion of the ellipse has two identical rectangles; the length and width of each of the two rectangles are coaxial with a major axis and a minor axis of the ellipse respectively, and the two rectangles are symmetrical with respect to an origin of the ellipse.

12. The system for mass production of a panoramic camera according to claim 7, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

13. The method for mass production of a panoramic camera according to claim 2, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

14. The method for mass production of a panoramic camera according to claim 3, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

15. The method for mass production of a panoramic camera according to claim 4, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

16. The method for mass production of a panoramic camera according to claim 5, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

17. The system for mass production of a panoramic camera according to claim 8, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

18. The system for mass production of a panoramic camera according to claim 9, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

19. The system for mass production of a panoramic camera according to claim 10, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.

20. The system for mass production of a panoramic camera according to claim 11, wherein a to-be-produced camera fixing apparatus is disposed at a geometric center position of the bottom of the calibration room, and the to-be-produced camera fixing apparatus comprises a tripod and a camera clamp; the tripod is configured to support the camera clamp and the to-be-produced camera, and the camera clamp is configured to clamp the to-be-produced camera; an optical axis of the to-be-produced camera is parallel to a horizontal plane of the bottom of the calibration room, and a height of the optical axis of the to-be-produced camera relative to the horizontal plane of the bottom of the calibration room is a half that of the calibration room; two opposite faces of side faces of the calibration room each comprise a black and white grid plate, and the two black and white grid plates are square plates with a 1:1 ratio of black to white; and the optical axis of the to-be-produced camera is perpendicular to the two black and white grid plates and passes through geometric centers of the two black and white grid plates.
